(19) United States
(12) Patent Application Publication
(10) Pub. No.: US 2023/0165266 A1
(43) Pub. Date: Jun. 1, 2023

(54) COMPRESSED TRUE WHOLE LEAF TEA DIPS AND METHOD THEREOF

(71) Applicant: TTLT INDIA PRIVATE LIMITED, Sivasagar (IN)

(72) Inventor: Upamanyu BORKAKOTY, Sivasagar (IN)

(21) Appl. No.: 17/801,268

(22) PCT Filed: Aug. 10, 2021
(86) PCT No.: PCT/IB2021/057376

§ 371 Date: Aug. 22, 2022

(30) Foreign Application Priority Data
Aug. 10, 2020 (IN) 202031034349

(51) Int. Cl. A23F 3/10; A23F 3/12; B65D 85/808

(52) U.S. Cl. CPC A23F 3/10; A23F 3/12; B65D 85/808

(57) ABSTRACT

The present invention relates to a method of preparing a compressed true whole leaf tea dip product. The method includes the step of tying the leaves with a string and step of compressing the tea leaves which results in preserving the shape of the leaves so that the tea leaves do not break and in unfurling of tea leaves without significant breakage. The way the tea leaves are plucked in the garden also plays an important role to preserve the shape without breakage when dipped in hot water during the preparation of tea beverage. In the present invention a natural unbroken true whole leaf tea dip is made from the leaves of the tea plant Camellia Sinensis and compressed in the smallest size possible in any desired weight or volume in a way to prevent the breakage of the tea leaves.

### FIELD OF THE INVENTION

Embodiments of the present disclosure relate to a method of processing and manufacturing true whole leaf tea dips in the smallest compressed form even more particularly in a form of a natural leaf tea dip connected by a string for brewing convenience without the use of any teabags.

### BACKGROUND OF THE INVENTION

Tea is a beverage that is ubiquitously enjoyed globally. For example, tea is the second most widely consumed beverage in the world, after water. Tea is derived from leaves of the plant Camellia Sinensis and can be processed in various ways, with various herbs and other ingredients from many sources, and with various flavours to produce various types of teas.

Typically, tea is brewed or infused using a hot (or in some cases, cold) solvent, such as water, to extract flavours, colours, and aroma from the tea source. People drink tea based on a variety of reasons, e.g., including the health benefits of certain teas, as a stimulant, for the flavour and aromas, and/or based on cultural behaviours.

Whole leaf tea does not undergo the wear and tear during tea production which allows it to retain more of its natural benefits and is generally considered better for health in comparison with other forms of tea. It is also believed, by tea lovers, to have better flavour and aroma. Whether it is a matter of preference or scientifically proven benefits, whole leaf tea has always been considered the better option for tea. However, a certain amount of breakage in the production, packaging and transportation of the wholeleaf tea is unavoidable at the moment.

Currently, there are several tea bag options available for the convenience of the consumer for brewing a single cup made from materials like paper, synthetic or natural fabrics etc. However, these tea bags contain processed orthodox tea leaves in the broken form or CTC teas (CTC is a common manufacturing technology for mass tea production) for easy infusion to extract flavours, colour and aroma from the tea source in lesser time possible. Whole leaf teas which are considered to be the best quality tea fails to deliver desired results when packed inside a teabag because the tea leaves require more space to unfurl to release the flavour, aroma or the colour when brewed with hot water. Similarly, dried herbs, flowers or spices which are generally blended with tea for tea bags are packaged in crushed or powdered form.

Also, some tea bags are made of polymers, nylon or plastics which releases micro plastic particles when brewed. Teabags are also bulkier than the processed tea leaves because of the added bag material which increases the volume of the packaging, which also ends up in a considerable amount of cost in transportation and packaging.

Therefore, there is a need for a tea processing and manufacturing process which can overcome the aforementioned issue.

### SUMMARY OF THE INVENTION

The following summary provides an introduction to selected concepts in a simplified form that are further described below in the detailed description. This summary is not intended to identify key features or essential features of the claimed subject matter, nor is it intended to be used as an aid in determining the scope of the claimed subject matter. Further, while certain disadvantages of other technologies may be noted or discussed herein, the claimed subject matter is not intended to be limited to implementations that may solve or address any or all of the disadvantages of those other technologies. The sole purpose of this summary is to present some concepts of the claimed subject matter in a simplified form as a prelude to the more detailed description that is presented below.

An object of the invention is to provide a method of preparing compressed true whole leaf tea dip prepared from the leaves of the tea plants Camellia Sinensis wherein the tea leaves unfurl without any breakage as a true unbroken whole leaf and remain in the same shape as it is plucked as soon as it is brewed.

Another object of the present invention is to provide a compressed true whole leaf tea dip for preparing tea beverage comprising compressed whole tea leaves of different sizes and tied to a string wherein the compressed leaves in the tea dip unfurl without significant breakage when dipped in hot water during the preparation of tea beverage.

Yet another object of the present invention is to provide a bagless tea dip product.

Yet another object of the present invention is to provide a tea dip product without the use of a paper, cloth or any other tea bag to hold the tea leaves.

Yet another object of the present invention to provide a tea dip product where the tea leaves unfurl without any breakage as a true unbroken whole leaf and remain in the same shape as it is plucked as soon as it is brewed.

Yet another object of the present invention to provide a tea dip product in the most compressed and smallest volumetric form without causing any breakage to the tea leaves which are also attached to a string.

Yet another object of the present invention to provide a tea dip product which makes the true unbroken whole-leaf tea brewing very convenient and effortless.

Yet another object of the present invention is to provide a tea dip with more wholesome flavour profiles as it does not contain broken whole leaf teas.

Yet another object of the present invention is to provide a compressed true whole leaf tea dip with innovative oxygenless packaging techniques to preserve the natural aroma and flavour present in the teas which are lost in the drying process.

Yet another object of the present invention is to provide a tea dip product in the compressed form and different customizable shapes, thereby changing the form and appearance of the loose tea leaves.

Yet another object of the present invention is to provide a tea dip product in the compressed form and without the use of a teabag but with all the conveniences of brewing tea just like any other tea bags.

According to one aspect of the invention, a method of preparing compressed true whole leaf tea dip is disclosed. The method includes

a) a step of withering of tea leaves to de-moisturize tea leaves;

b) a step of shaking and rolling of tea leaves to breakdown the cell structure of tea leaves and allow the oxidation process;

c) a step of fermenting the processed leaves to reduce astringency and bitterness;

d) a step of de-enzyming the processed leaves to deactivate the enzymes (enzymatic reaction);

e) a step of baking the processed leaves to add flavor;

f) a step of sorting the processed tea leaves to separate whole tea leaves from the damaged tea leaves;

g) a step of tying the leaves with a string to tie the individual leaves together;

h) a step of compressing the tea leaves to reduce the moisture content in the tea leaves and to provide a compressed form of tea leaves which helps in retaining the whole leaf nature of the leaves without breakage;

i) a step of disinfecting the tea leaves to reduce the microbial load;

j) a step of drying the tea leaves to further reduce the moisture content in the tea leaves and prepare the leaves for packaging with a longer shelf life;

k) a step of packaging the tea leaves to transport the tea leaves for making the tea leaves for ready-to-use;

According to one aspect of the invention, the step of tying the leaves with a string and step of compressing the tea leaves result in unfurling of tea leaves without significant breakage when dipped in hot water during the preparation of tea beverage.

According to one aspect of the invention, a compressed true whole leaf tea dip for preparing tea beverage is disclosed. The compressed leaves in the tea dip unfurl without significant breakage when dipped in hot water during the preparation of tea beverage.

Other features of the embodiments will be apparent from the accompanying drawings and from the detailed description that follows.

### BRIEF DESCRIPTION OF THE DRAWINGS

Example embodiments of the present invention are illustrated by accompanying drawings, wherein:

FIG. 1 depicts flow chart for the preparation of compressed true whole leaf tea dips according to one embodiment of the present invention;

The drawings described herein are for illustration purposes only and are not intended to limit the scope of the present invention in any way.

### DETAILED DESCRIPTION OF THE INVENTION

It is to be understood that the present disclosure is not limited in its application to the details of composition set forth in the following description. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item.

Reference throughout this specification to “one embodiment,” or similar language means that a particular feature, structure, or characteristic described in connection with the embodiment is included in at least one embodiment of the present invention. Thus, appearances of the phrases “one embodiment,” and similar language throughout this specification may, but do not necessarily, all refer to the same embodiment, different embodiments, or component parts of the same or different illustrated invention.

The present invention provides one or more ways of producing whole leaf tea dips in the smallest compressed form tied by a string to use as a natural tea dip for convenience of brewing in water or milk without the use of a bag. It will make high-quality tea brewing easy on the go and without the use of strainers or any other tea brewing equipment. Each and every tea dip will make the true whole leaf quality tea brewing possible without any leaf breakages and will also save a lot of space in packaging because of its compressed state.

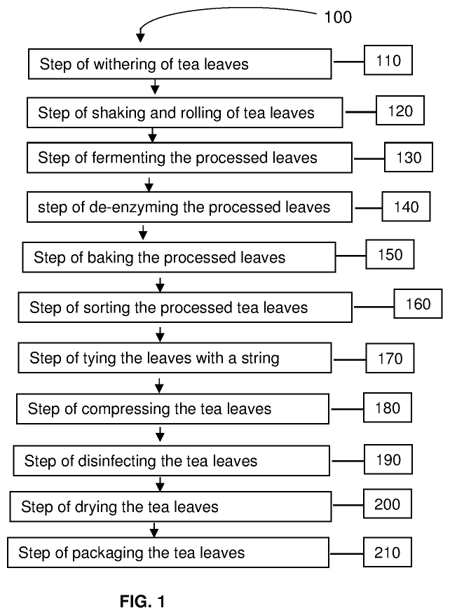

The method for preparing compressed true whole leaf tea dip (100) is disclosed in FIG. 1, As shown in FIG. 1, the method includes:

a) a step of withering of tea leaves to de-moisturize tea leaves (110);

b) a step of shaking and rolling of tea leaves to breakdown the cell structure of tea leaves and allow the oxidation process (120);

c) a step of fermenting the processed leaves to reduce astringency and bitterness (130);

d) a step of de-enzyming the processed leaves to deactivate the enzymes (140);

e) a step of baking the processed leaves to add flavor (150);

f) a step of sorting the processed tea leaves to separate whole tea leaves from the damaged tea leaves (160);

g) a step of tying the leaves with a string to tie the individual leaves together (170);

h) a step of compressing the tea leaves to reduce the moisture content in the tea leaves and to provide a compressed form of tea leaves which helps in retaining the whole leaf nature of the leaves without breakage (180);

i) a step of disinfecting the tea leaves to reduce the microbial load (190);

j) a step of drying the tea leaves to further reduce the moisture content in the tea leaves (200);

k) a step of packaging the tea leaves to transport the tea leaves for making the tea leaves for ready-to-use (210);

According to one embodiment of the invention, the step of tying the leaves with a string (170) and step of compressing the tea leaves (180) result in unfurling of tea leaves without significant breakage when dipped in hot water during the preparation of tea beverage.

According to one embodiment of the invention, the present method for preparing compressed true whole leaf tea dip provides a bagless tea dip product.

According to one embodiment of the invention, the natural unbroken whole leaf tea dip is produced as below:

A processing unit in a tea garden of 0-500 kilometres radius is established. The plucked green leaves from the certified organically grown or naturally and sustainably grown or inorganically grown tea gardens are procured to the processing unit.

For tea types such as Black, Oolong, White and Puerh tea, the corresponding green leaves are left for withering (110) in an automatic withering trough which blows both cool and hot air as per set parameters for oxidization for a certain amount of time depending on the kind of characteristics desired for drinking the respective tea. Cool air is being blown in temperatures ranging between 2-30 deg Celsius and the hot air is being blown in a range of 60-100 deg Celsius. The moisture content removal in the withering phase ranges between 0.1-70%. Withering (110) is followed by processes like shaking of the tea leaves and rolling the leaves (120), fermenting the processed leaves (130) depending on the process requirements.

According to one embodiment of the invention, in the case of black, Oolong, white and Puerh tea, the next stage is de-enzyming (140) to stop the enzymatic reaction up to the desired level. De-enzyming (140) of the fermented/oxidised leaves can be done by steaming, panning, passing through micro-wave, hot air blasting etc. In the oxidised state, the tea leaves contain a lot more moisture than the dried state which can also be termed as a semi-dried state. In this phase the flavour profiles and the aroma of the teas are at its peak because of the high presence of active ingredients and components present in tea, which eventually reduces after the drying process.

The next step after de-enzyming (140) is the step baking the processed leaves (150).

According to one embodiment of the invention, the next step is step of sorting the processed tea leaves (160). The de-enzyme oxidised and baked leaves are brought for weighing and sorting either through hand or through a sorting machine assisted by an inbuilt weighing sensor. Tea leaves for one cup shall be measured and kept in a separate small-sized tray where several similar trays shall be spread over an area to segregate the whole batch of fermented leaves. Similarly, tea leaves for 1 teapot, 1 jar, 1 bottle or of any amount can be set to segregate accordingly.

After the segregation of required amount of tea leaves for each cup is done, the leaves are held together by the lower part of the leaf which connects with the nodes in a stem and is held tight. This process can be done both by hand or a machine to gather all the leaves together. Next, the leaves are tied (170) with a string, yarn or thread of any material leaving the other end little longer forming a string for a tea dip as it can be seen in a teabag. The only visible difference is that there will be natural tea leaves tied to the string instead of a teabag. The other loose end of the thread, string or yarn could range between 1 centimetre to 30 centimetres, However, a length of 4 to 12 centimetre will serve the purpose.

According to one embodiment of the invention, the tied fermented leaves in the semi-dried state shall be shifted for compression to compress the tea leaves (180) and also to give the desired shape in the smallest size possible. A compression chamber is developed and the interior of the compression chamber is designed in the desired shape as required in the finished tea like cube, sphere, oval, star or any other shape, which will compress the tea leaves. Accordingly, a piston is developed to compress the tea in its semi-dry state. The tied tea leaves are put inside the compression chamber while keeping the string out of the chamber through an outlet. The pressure is applied to the piston to compress the leaves in the desired shape and in the most compressed form. To make the job faster the same process shall be replicated in several compression chambers with the desired amount of leaves for the desired output. The compression can be done both manually or with other forms of pressures like hydraulic, electric, mechanic, pneumatic or any other form to apply pressure. Because of the high moisture content in the tea leaves, the leaves get compressed without any breakages. Compressing the leaves can also be done by tightly wrapping the string, yarn or a thread around the leaves by holding them together and later same string can be used as a dip by unwrapping the leaves as the other end of the string will be tying the leaves together.

The compressed tea leaves with its dip string attached are next passed through UV chambers to disinfect (190) and reduce contaminations from various pathogens. The final step is the drying process (200) through different methods like heat drying, freeze-drying etc. Freeze drying, however, retains more flavour than heat drying.

Drying (200) is the last step in tea manufacturing and after that paper, tags are attached to the other end of the string/yarn/thread etc either manually or through the use of machines.

The final product is packed (210) into different food-grade packaging materials. The final product is bagless tea dip in compressed form packaged into different boxes.

Consumers will be able to easily brew a cup of tea with the truest unbroken whole leaf quality by just adding water or milk as desired in a cup or a glass or any other container. As soon as the compressed leaves come in contact with hot/cold water/milk the leaves start to unfurl and start releasing its aroma, flavour and colour in its most natural whole-leaf form. Once the brewing is done the consumer can pull the string which is tied to the leaves to take out the leaves from the cup to prevent over steeping. This method of tea production also eliminates the use of tea strainers or any other tea brewing apparatus to brew a specialty cup of true whole leaf tea even on the go.

According to one embodiment of the invention, the method for preparing compressed true whole leaf tea dip changes according to the type of tea leaf. In the case of green tea, the steps of shaking, rolling and baking and fermentation are absent. In the case of green tea, after withering and moisture removal the next step is de-enzyming, followed by sorting and weighing of the leaves.

According to one embodiment of the invention, the step of drying is replaced with providing vacuum and nitrogen flush.

According to one embodiment of the invention, to preserve the active flavour profiles and aroma in the compressed tea leaves in the semi-dried state avoid the drying the process and also avoid its contact with oxygen or air. Prolonged contact with oxygen or air will lead to further oxidation or fermentation of the compressed tea leaves in the semi-dried state, which will further activate the enzymatic reaction and will result in the loss of the tea flavour and aroma.

According to one embodiment of the invention, to achieve the airtight packaging material in any material such as flexi pack, aluminium cans, or any other material that can withstand high air and vacuum pressures is used. The compressed tea attached to the string and the tag shall be put inside the packaging material more preferably a flexible packaging in bio-degradable, compostable, recyclable or any other materials and then the air is completely sucked out to create a vacuum environment inside the packaging material. After this pure food-grade nitrogen is flushed into the packaging which contains the compressed tea in semi-dried state and nitrogen will replace all the air molecules which will eventually stop the teas from getting further oxidised and also to stop the enzymatic reaction inside the package. After this the packaging material more preferable the flexi packaging material shall be sealed to lock the nitrogen inside the package. This whole process will enhance the shelf life of the compressed tea dips in semi-dried from and also preserve the active flavour profiles which are at least 2 times more than any completely dried teas which contain moisture only up to 7%. In certain cases, the completely dried teas may contain moisture level up to 15% or more but they are more prone to getting damaged within a shorter period.

According to one embodiment of the invention the whole method of making tea brewing makes a consumer more enjoyable, effortless and easy with the truest unbroken whole leaf quality by just adding water or milk as desired. As soon as the compressed leaves in the semidried state comes in contact with hot/cold water/milk, the leaves start to unfurl even faster than the completely dried compressed tea leaves and starts releasing its aroma, flavour and colour in its most natural form which is at least 2 times more flavour than completely dried compressed tea leaves. Once the brewing is done the consumer can pull the string which is tied to the leaves to take out the leaves from the cup to prevent over steeping. This method of tea production also eliminates the use of tea strainers or any other tea brewing apparatus to brew a specialty cup of true whole leaf tea even on the go with at least 2 times more flavour than with completely dried tea leaves.

According to one embodiment of the invention, the afore-mentioned processes specifically mention about producing tea from the tea plant Camellia Sinensis. However, the tea can also be blended with a wide variety of herbs, flowers, roots, spices and other plant materials before compressing the tea leaves in the compression chamber. The blending could be done in any form, shape, varieties or in any process before compressing the true whole-leaf tea dips as per the processes mentioned above to achieve the desired taste. The blended tea could also be called as a compressed true whole leaf or whole spices tisanes or herbal tea. As soon as the compressed tea are brewed the herbs, spices, roots or any other plant material blended with tea i.e Camellia sinensis or without tea starts releasing its flavour. These herbs, roots, spices or any other plant material could also be blended in the form of naturals oils, water-soluble oils, extracts, natural powders or in semi-crushed form with tea leaves or without tea leaves and then compress as per the processes mentioned above to give it the desired shape.

It will be recognized that the above described subject matter may be embodied in other specific forms without departing from the scope or essential characteristics of the disclosure. Thus, it is understood that, the subject matter is not to be limited by the foregoing illustrative details, but it is rather to be defined by the appended claims.

While specific embodiments of the invention have been shown and described in detail to illustrate the novel and inventive features of the invention, it is understood that the invention may be embodied otherwise without departing from such principles.

I/We claim:

1. A method of preparing compressed true whole leaf tea dip (100), the method comprising:
a) a step of withering of tea leaves to de-moisturize tea leaves (110);
b) a step of shaking and rolling of tea leaves to breakdown the cell structure of tea leaves and allow the oxidation process (120);
c) a step of fermenting the processed leaves to reduce astringency and bitterness (130);
d) a step of de-enzyming the processed leaves to deactivate the enzymes (140);
e) a step of baking the processed leaves to add flavor (150);
f) a step of sorting the processed tea leaves to separate whole tea leaves from the damaged tea leaves (160);
g) a step of tying the leaves with a string to tie the individual leaves together (170);
h) a step of compressing the tea leaves to reduce the moisture content in the tea leaves and to provide a compressed form of tea leaves which helps in retaining the whole leaf nature of the leaves without breakage (180);
i) a step of disinfecting the tea leaves to reduce the microbial load (190);
j) a step of drying the tea leaves to further reduce the moisture content in the tea leaves (200);
k) a step of packaging the tea leaves to transport the tea leaves for making the tea leaves for ready-to-use (210);
characterized in that
the step of tying the leaves with a string (170) and step of compressing the tea leaves (180) result in unfurling of tea leaves without significant breakage when dipped in hot water during the preparation of tea beverage.

2. The method of preparing compressed true whole leaf tea dip (100) as claimed in claim 1, wherein the moisture content of the compressed tea leaves in the semi-dry state is in the range of 10 to 40%.

3. The method of preparing compressed true whole leaf tea dip (100) as claimed in claim 1, wherein the moisture content of the compressed tea leaves after the final drying state is in the range of 3 to 5%.

4. The method of preparing compressed true whole leaf tea dip (100) as claimed in claim 1, wherein the tea leaves used are unbroken fresh or semi-processed whole tea leaves.

5. The method of preparing compressed true whole leaf tea dip (100) as claimed in claim 1, wherein the size of the leaf used can be varied as per the requirement.

6. The method of preparing compressed true whole leaf tea dip (100) as claimed in claim 1, wherein the leaves unfurl without any significant breakage during the preparation of tea beverage.

7. The method of preparing compressed true whole leaf tea dip (100) as claimed in claim 1, wherein the user can brew 2 to 3 cups of tea with one piece of bagless whole leaf compressed tea dip.

8. The method of preparing compressed true whole leaf tea dip (100) as claimed in claim 1, wherein the whole tea leaves are selected from black tea, green tea, oolong tea, Puerh tea, white tea.

9. A compressed true whole leaf tea dip for preparing tea beverage, the tea dip comprising:
compressed whole tea leaves of different sizes and tied to a string;
characterized in that
the compressed leaves in the tea dip unfurl without significant breakage when dipped in hot water during the preparation of tea beverage.

10. The compressed true whole leaf tea dip for preparing tea beverage as claimed in claim 9, wherein the string acts as steeping agent during the preparation of tea beverage.
